(19) United States
(12) Patent Application Publication
(10) Pub. No.: US 2025/0273095 A1
(43) Pub. Date: Aug. 28, 2025

(54) LAMINATE AND METHOD FOR PRODUCING A LAMINATE

(71) Applicant: OVD Kinegram AG, Zug (CH)

(72) Inventors: Marcus ARNOLD, Zug (CH); Sandra PETER, Zug (CH)

(21) Appl. No.: 18/858,811

(22) PCT Filed: Apr. 19, 2023
(86) PCT No.: PCT/EP2023/060062

§ 371 Date: Oct. 22, 2024

(30) Foreign Application Priority Data
Apr. 25, 2022 (DE) 10 2022 109 850.8

(51) Int. Cl. G09F 3/03; B32B 3/30; B32B 7/12; B32B 27/08; B32B 27/36

(52) U.S. Cl. CPC G09F 3/03; B32B 3/30; B32B 7/12; B32B 27/08; B32B 27/365; B32B 2307/412; B32B 2307/416; B32B 2307/54; B32B 2307/7376; B32B 2425/00

(57) ABSTRACT

A laminate (1) including a security element (20), which is laminated in between a record layer (11) and a cover layer (12), wherein an adhesive layer (25) adheres to the record layer (11) and a detachment layer (21) adheres to the cover layer (12) or the adhesive layer (25) adheres to the cover layer (12) and the detachment layer (21) adheres to the record layer (11) and the laminate (1) is designed such that the adhesive layer (25) of the security element (20) can be split up by a tensile force exerted on the security element (20) by the record layer (11) and the cover layer (12), as well as to a method for producing a laminate (1).

The invention relates to a laminate and a method for producing a laminate.

It is known to enclose security elements in laminates, such as security documents, between two layers which are joined to each other in a material-bonding manner, with the result that the security element is completely enclosed by these two layers of the security document. The material-bonding join achieves a high adhesive force and protects the security element from damage and manipulations. Because of the different material properties of the layers of the security element and the adjacent layers of the security document joined in a material-bonding manner, however, different boundary surfaces with different adhesive force and in particular with reduced adhesive force form at the boundary surfaces of the security element. If the security element has different adhesive forces at its boundary surfaces to the layers joined in a material-bonding manner, this can be used by forgers to remove the security element by a targeted delamination or peeling off of the layers of the security document or to add false information to the security document and seal it again.

An object of the present invention is therefore to specify a laminate, in particular security document, which has an improved protection against manipulation and forgery, as well as to specify a method for producing it.

The object is achieved by means of a laminate, in particular security document, according to claim 1. The laminate, in particular security document, comprises a record layer, a transparent cover layer and a security element, which is laminated in between the record layer and the cover layer. The security element has a detachment layer, a replication layer with a relief surface arranged on its side facing away from the detachment layer, a reflective layer arranged on the relief surface and an adhesive layer. The adhesive layer forms a side of the security element facing away from the detachment layer, wherein
a) the adhesive layer adheres to the record layer and the detachment layer adheres to the cover layer or the adhesive layer adheres to the cover layer and the detachment layer adheres to the record layer.

In addition,
b) the laminate is designed such that the adhesive layer of the security element can be split up by a tensile force exerted on the security element by the record layer and the cover layer.

The object is further achieved by a method according to claim 31. In the method for producing a laminate, in particular a security document, preferably according to one of claims 1 to 30, the following steps are carried out, in particular in the specified order:
preparing a record layer;
preparing a transparent cover layer;
preparing a security element, in particular a security element such as is described for the laminate according to the invention, preferably in one of claims 1 to 30. The security element has a detachment layer, a replication layer with a relief surface arranged on its side facing away from the detachment layer, a reflective layer arranged on the relief surface and an adhesive layer, which forms a side of the security element facing away from the detachment layer. The security element is or has been attached to the cover layer or to the record layer with the adhesive layer;
laminating the security element in between the record layer and the cover layer such that
a) the adhesive layer adheres to the record layer and the detachment layer adheres to the cover layer or the adhesive layer adheres to the cover layer and the detachment layer adheres to the record layer, and
b) the adhesive layer of the security element can be split up by a tensile force exerted on the security element by the record layer and the cover layer.

The adhesive layer of the laminate according to the invention and of the laminate that can be obtained by the method according to the invention can in particular be split up by means of a cohesive failure by a tensile force exerted on the security element by the record layer and the cover layer. The presence of an adhesive layer that can be split up within the meaning of the present invention can be ascertained in particular by the peel tests described below. A cohesive failure is in particular the breakdown of the bonding in the adhesive itself, preferably wherein the adhesion of the adhesive on the material surface is greater than the internal strength of the adhesive. In the case of a cohesive failure in the adhesive layer, in particular a separation of the adhesive layer into two partial layers takes place, wherein the partial layers of the adhesive layer separated from each other in each case continue to adhere to the directly adjacent layers neighboring the adhesive layer. In particular, the two partial layers are in each case contiguous layers which have been or are separated from each other by the cohesive failure, wherein a pure cohesive failure is preferably present. There is the possibility that a spreading crack tip temporarily hits the boundary surface of the layers neighboring the adhesive layer during the cohesive failure, but does not run along it in the case of an ongoing separation, for example such that after the separation the adhesive layer is present in the form of in each case not completely contiguous partial layers and/or such that after the separation the adhesive layer is present in the form of in each case as predominantly contiguous partial layers. In the case of an adhesive failure, on the other hand, the adhesive layer loosens in particular at the boundary surface with one or more of the layers directly adjacent to the adhesive layer and neighboring the adhesive layer, in particular with the result that the adhesive layer is detached from the boundary surface in a contiguous or predominantly contiguous manner by the adhesive failure.

Due to the presence of an adhesive layer that can be split up, an undetectable detachment or re-use of the security element as a whole is made more difficult since, when the cover layer is peeled off, because the adhesive layer is split up, in particular because of a cohesive failure of the adhesive layer, a part or a partial layer of the adhesive layer is also peeled off and thus the layer thickness of the security element is reduced, and plastic deformations of the adhesive layer persist in particular on the surface of the security element. A manipulation attempt is thus advantageously more easily detectable, or the detectability can be reduced only by additional effort. Studies have moreover shown that an increased peeling-off force, preferably also called peel force, which is necessary in the case of an attempt to detach the cover layer or the record layer from the security element, can be achieved through the adhesive layer that can be split up or due to a corresponding predetermined breaking point defined by the adhesive layer. A delamination of the laminate and a non-destructive re-use of the security element is therefore made more difficult because of the prevailing adhesive force conditions. Thus, a particularly high adhesive force both at the boundary surface of the adhesive layer and at the boundary surface of the detachment layer with the adjacent record layer or with the adjacent cover layer can furthermore also be achieved, whereby in particular the difference between the adhesive forces at the two boundary surfaces of the adhesive layer can be adapted and the difference can in particular be reduced such that a successive detachment of layers of the security document that is easy to control is made more difficult.

In particular, the laminate according to the invention is produced with the method according to the invention. The method according to the invention is thus preferably carried out to obtain the laminate according to the invention.

Advantageous designs of the invention are described in the dependent claims.

By “adhere” is preferably meant a direct joint. The adhesive layer preferably adheres directly to the record layer, wherein the detachment layer adheres directly to the cover layer, or the adhesive layer adheres directly to the cover layer, wherein the detachment layer adheres directly to the record layer. In particular, the adhesive force of two layers adhering to each other lies above a value of 1 N/10 mm strip width, preferably above 1.5 N/10 mm strip width, further preferably above 3.5 N/10 mm strip width, measured according to the standard ISO/IEC 10373-1: 2006 (E); paragraph 5.3 and/or the peel test below. In further embodiments, intermediate layers can be arranged between the adhesive layer and the record layer.

By a layer is meant in particular a substantially two-dimensional structure. A layer can itself preferably be single- or multi-layered.

By a laminate is meant in particular a multi-layered structure, of which at least two layers are joined to each other in a material-bonding manner, in particular are welded. For example, a laminate is or has been produced by means of a laminating method. The laminating method can be carried out as described further below. By laminated in or laminating in is meant in particular that a material-bonding join, in particular of record layer and cover layer, has been or is produced preferably by means of a laminating method, preferably with the result that the security element is completely enclosed by the two layers. The security element has been or is in particular laminated in by welding the record layer and the cover layer and by preferably completely surrounding the security element, preferably when viewed perpendicular to a plane or main surface spanned by the laminate and/or the security element.

By a plane or main surface is preferably meant the surface which the laminate or the security element or one of the layers of the laminate and/or of the security element spans if its thickness is disregarded.

By “transparent” is preferably meant a transmittance of over 90%, in particular wavelengths in a range of from 380 nm to 780 nm, preferably for wavelengths in the wavelength range visible to the human eye.

By “semi-transparent” is preferably meant a transmittance in a range of from 30% to 90%, in particular wavelengths in a range of from 380 nm to 780 nm, preferably for wavelengths in the wavelength range visible to the human eye.

By “opaque” is preferably meant a transmittance of less than 30%. By transmittance is preferably meant the ratio of the quantity of a light irradiating and/or incident on a medium to the quantity of light which emerges on the opposite side of the medium, wherein in particular no change in the frequency or the wavelength of the light has taken place. The light not transmitted is preferably reflected, scattered and/or absorbed by the medium. Thus, in the case of a transmittance of a medium of 0.9 or 90%, for example, 90% of the irradiating light is perceptible on the opposite side of the medium.

When the transmittance of a layer is considered, reflections at the boundary surfaces of this layer in particular are not taken into account.

It is possible for a security element to provide an optically variable effect. An optically variable effect can in particular be selected individually or in combination from: color change dependent on the angle of view, contrast change dependent on the angle of view, motif change dependent on the angle of view, holographic representation, cinematographic representation. The angle of view of the security element can be varied by an observer in particular by a tilting, turning and/or bending. A security element preferably has been or is formed as a or of a transfer ply of a transfer film. It is possible for one or more security elements to have been or to be laminated in a security document with an adhesive layer adhering to the record layer and a detachment layer adhering to the cover layer and for one or more further security elements to have been or to be laminated in a security document with an adhesive layer adhering to the cover layer and a detachment layer adhering to the record layer.

The record layer and/or the cover layer preferably comprises or consists of polycarbonate. It is advantageous in particular if the record layer and the cover layer comprise or consist of polycarbonate and in particular have been or are joined to each other in a material-bonding manner, in particular welded together, by means of the laminating-in. During the laminating-in a particularly stable join can thus be achieved. The cover layer preferably has a layer thickness in a range of from 25 μm to 250 μm and/or the layer thickness of the cover layer, in relation to the layer thickness of the adhesive layer, lies in a range of from 1.25 to 250 and/or the sum of the thickness of the adhesive layer and the thickness of the cover layer lies in a range of from 26 μm to 270 μm.

In addition to polycarbonate, for example the cover layer and/or the record layer can in particular also contain dyes, in particular color pigments and/or effect paints, for example with optically variable pigments (OVI) and/or with metallic pigments.

It is preferred that the record layer has a thickness in a range of from 25 μm to 250 μm. The record layer is processable in particular by means of a laser or is processed by means of a laser. The record layer preferably contains further substances, such as in particular a doping. The capacity of the record layer to absorb energy can be increased by means of the doping. Materials for a doping are selected in particular from one or more of the following materials: chromium, erbium, neodymium, praseodymium, titanium, ytterbium. Thus, an item of information has been or is inscribed in the record layer for example by means of a laser, preferably a YAG laser, preferably a Nd:YAG laser (abbreviation for neodymium-doped yttrium-aluminum-garnet laser). The emitted wavelength of the YAG laser is preferably 1064 nm. The cover layer is preferably transparent for the wavelength of 1064 nm and/or that of the laser. The record layer is thus processable by means of a laser in particular through the cover layer, in order to inscribe items of information in the record layer. The security element preferably overlaps such items of inscribed information and thus increases the protection against forgery of the laminate, in particular security document.

It is possible for the adhesive layer to adhere to the cover layer or the record layer via a material-bonding, in particular an adhesive, joint. The detachment layer preferably adheres to the cover layer or the record layer via a welded joint, in particular without an intermediate adhesive joint. In particular, the cover layer and the record layer, and preferably also the detachment layer, form a monolithic body. The joining of the security element over the adhesive layer and over the detachment layer is thus preferably based on different physical principles, which preferably make a detachment of the security element on the detachment layer side very complex to impossible. The adhesive layer preferably adheres to the reflective layer through a material-bonding joint and/or to the replication layer through a material-bonding joint. The reflective layer adheres to the replication layer in particular via a material-bonding joint.

A material-bonding join of record layer and cover layer, for example in the form of polycarbonate layers, in particular consisting of almost 100% polycarbonate, which is achieved advantageously by a welding together in a laminating method, are regarded as ideally joined to each other and thus provide a forger with few possibilities for separating the individual layers from each other without destroying them. For example, a separation of the layers cannot be easily achieved by exerting a tensile force on a boundary surface. However, the security element laminated therein acts in the structure in particular as a foreign body, i.e. the adhesion to neighboring cover layer and record layer, in particular to neighboring polycarbonate layers, is greatly reduced compared with the adhesion directly between cover layer and record layer. In order to extract the security element from the laminate, a forger could cut into the polycarbonate layers before a splitting at the edge of the security element and then attempt to peel one of the layers off. This procedure was replicated by the tests below and can be made even more difficult by a predetermined breaking point provided by the adhesive layer for a cohesive failure and furthermore preferably selected geometry and material parameters, for example by increasing the peel force.

The measurement of the peel force can in particular be carried out as described in the following, preferably by means of a peel test on the laminate. The peel force is in particular also called peel strength, peel-off force, pull-off force or adhesive force. The peel force can in particular be measured by a peel test according to ISO/IEC 10373-1: 2006 (E); paragraph 5.3 and/or according to the peel test described below.

In the peel test an optionally pre-conditioned laminate, preferably in the form of a card, is in particular cut into test strips 10 mm wide.

For example, the layer or all layers on one side of the security element is or are then removed, thus for example the corresponding part of the record layer or of the cover layer is removed, preferably with a length of from 5 mm to 10 mm. The layers above the security element, in particular a KINEGRAM®, are stripped off the core for example with a sharp knife, i.e. in particular the cover layer is stripped off the record layer or the record layer is stripped off the cover layer. The stripping expediently takes place only partially.

The stripped-off end, in particular of the cover layer, is then preferably secured to the holder of a tensile testing machine via a holding clamp or by means of an adhesive tape. A right angle is preferably produced between the stripped-off layers secured to the tensile testing machine and the layers not stripped off. In particular, a right angle is produced between the cover layer and the record layer. The bottom of the laminate, in particular the record layer, is expediently optionally fixed on a stabilizing plate.

During the tensile measurement the detached film layer can preferably be guided over a roller. The adhesive force (peel strength) is preferably plotted on a graph and then evaluated, wherein the first and last 5 mm of the measurement are preferably not taken into account. The results are given for example in N/10 mm.

It is also possible for the measurement to be performed at locations without a security element, for example in order to measure the adhesive force between the cover layer and the record layer.

It has in particular proved to be advantageous to reduce the adhesive layer thickness in direct proportion to the thickness of a stabilization layer preferably arranged between the adhesive layer and the replication layer, in order in particular to guarantee a cohesive failure, in particular if the adhesive layer adheres to the record layer.

It is advantageously possible for a peel force for detaching the cover layer from the security element which is equal to or greater than 3.5 N/10 mm strip width to have been or to be provided in the laminate.

The adhesive layer preferably serves to bind a transfer ply which carries one or more security elements according to the invention to the substrate during the application, i.e. in particular when the security element is applied to the cover layer or the record layer as substrate. This can be an adhesive layer which is activated by means of heat and pressure. Such an adhesive layer to be activated by means of heat and pressure can in particular have thermoplastic properties or also be crosslinked by the action of heat, whereby a new activation by heat can be prevented. It is also possible for such an adhesive layer, as a hybrid layer, to have thermoplastic portions and crosslinking constituents. A heated stamp, the shape of which defines the region to be transferred, is typically used for the activation.

Alternatively, a transfer can be effected by means of a so-called cold transfer. The adhesive layer is printed, preferably onto the transfer ply of a transfer film or onto the cover layer or the record layer, then the cover layer or the record layer is brought into contact with the transfer ply and the adhesive layer is cured, in particular such that the security element is formed of the transfer ply and the printed adhesive layer. The curing is in particular effected by means of UV radiation. The adhesive layer can be constructed of several different layers and include for example one or more adhesion-promoter layers, in order in particular to ensure the binding of the adhesive layer to the reflective layer or to the optionally present stabilization layer.

An adhesive force of the adhesive layer to its directly neighboring layer consisting of cover layer or record layer is advantageously higher than the cohesive force of the adhesive layer. An adhesive force within the adhesive layer, in particular a cohesive force of the adhesive layer, is preferably lower than an adhesive force between the security element and the record layer and also lower than an adhesive force between the security element and the cover layer.

It is advantageous in particular if the adhesive layer has the lowest yield point, in particular the lowest upper yield point, and/or the lowest elastic modulus of the layers of the security element, the record layer and/or the cover layer. A lowest force out of cohesive and adhesive forces within the security element or within the laminate with the security element is preferably the cohesive force of the adhesive layer.

It is also possible for the adhesive layer to have or to consist of a ductile layer, in particular wherein by a ductile layer is meant a layer with the greatest elongation at break in the security element in comparison with the other layers of the security element.

It is hereby possible for the adhesive layer to have or to consist of a ductile layer, wherein this ductile layer is the layer that can be split up by a cohesive failure. The cohesive failure is advantageously favored, or an adhesive failure is made more difficult and in particular the peel force is increased, by the ductile layer, in particular compared with a brittle adhesive layer.

It is possible in particular for the laminate to be designed such that, during the peel test and/or an attempt to detach the cover layer and/or the record layer from the laminate, a pure cohesive failure takes place or the adhesive layer detaches in one or more partial surfaces at a boundary surface with a layer directly neighboring it consisting of cover layer or record layer. This can be the case in particular in the event of a partial adhesive failure. However, these one or more partial surfaces preferably have a smaller surface area than a residual surface of the boundary surface, which preferably shows no detachment of adhesive layer and neighboring layer. The residual surface of the boundary surface has in particular residues of the adhesive layer, since a cohesive failure is present there. The laminate is preferably designed such that the one or more partial surfaces occupy such a small surface area that the peel force is at least 3.5 N/10 mm, preferably measured with the peel test. For this, for example, the layer thickness of the adhesive layer can be adapted correspondingly and/or the optionally present stabilization layer can be used.

It is preferred that the residual surface covers at least 50%, at least 80%, preferably at least 90%, of the surface area of the boundary surface and/or the one or more partial regions cover less than 50%, preferably less than 20%, preferably less than 10%, of the surface area of the boundary surface.

Here, viewing takes place in particular along a line perpendicular to a plane spanned by the boundary surface. Overall a high peel force can thus advantageously be guaranteed also in the case of irregularities in the laminate, which can lead for local peaks in tensile stress and thus local adhesive failures. In an advantageous embodiment the adhesive layer, in particular the ductile layer, comprises a material with an elastic modulus (elastic modulus=modulus of elasticity) in a range of from 20 MPa to 300 MPa, preferably from 50 MPa to 200 MPa, preferably from 75 MPa to 150 MPa. The elastic modulus is determined in particular in each case according to DIN EN ISO 527-3:2003-07 (“Plastics—Determination of tensile properties—Part 3: Test conditions for films and sheets—issue date: 2003-07), preferably at room temperature (25° C.). The modulus of elasticity in tension is ascertained here on film test strips by means of a tensile testing machine, for example a tensile testing machine from ZwickRoell GmbH & Co. KG, Ulm, DE. The width of the film strips is preferably 15 mm+/−0.1 mm, the length of the film strips is preferably 100 mm+/−0.5 mm or preferably 50 mm+/−0.5 mm for film materials with high elongation in particular. The test speed for a film length of 100 mm is 10 mm/min+/−1 mm/min or the test speed for a film length of 50 mm is 5 mm/min+/−1 mm/min.

The adhesive layer is in particular arranged over the whole surface and continuously in the security element. It can hereby be achieved that, in particular when the cover layer is peeled off, differences in stress which would favor an adhesive failure are prevented.

In particular, the adhesive layer contains thermoplastics or crosslinking or crosslinked polymers, in particular polymethyl methacrylate and/or polybutyl methacrylate.

By crosslinking is meant in particular a chemical reaction in which macromolecules, in particular polymers, are linked to form a three-dimensional network, preferably a polymerization.

The adhesive layer preferably has been or is produced on the basis of the following materials selected individually or in combination from polymethyl methacrylate and polybutyl methacrylate. It is also possible for the adhesive layer to comprise one or more additives, selected individually or in combination from fillers, such as for example TiO₂, BaSO₄ or silica.

The adhesive layer preferably has a glass transition temperature Tg in a range of from 20° C. to 50° C. Furthermore, a melting temperature Tm of the adhesive layer in a range of from 40° C. to 150° C. is preferred. In particular, the molar mass of the adhesive layer lies in a range of from 100 kg/mol to 350 kg/mol.

The adhesive layer has in particular a thickness in a range of from 0.2 μm to 20 μm, preferably in a range of from 0.2 μm to 10 μm. It is particularly preferred if the adhesive layer has a thickness in a range of from 3.5 μm to 20 μm, further preferably from 3.5 μm to 10 μm, and/or in a range of from 4 μm to 20 μm, further preferably from 4 μm to 10 μm, and/or in a range of from 6 μm to 20 μm, in particular from 6 μm to 10 μm.

The adhesive layer is preferably transparent or semi-transparent. The adhesive layer can have a milky white optical impression. The cohesive failure in the adhesive layer can advantageously be particularly easily detected optically through a semi-transparent and/or milky white adhesive layer. For this, e.g. TiO₂ can be comprised by the adhesive layer.

It is possible for the adhesive layer to have a slightly rough surface before the application. The surface roughness preferably lies between 0.4 μm and 2.0 μm, in particular between 0.6 μm and 1.0 μm. The measurements necessary for this are preferably carried out with a microscope, in particular with a Keyence VK-X3000, and the software necessary for it, possibly VK Analyzer.

The detachment layer has in particular a thickness in a range of from 0.2 μm to 10 μm, preferably in a range of from 0.2 μm to 5 μm. The detachment layer comprises or consists of materials selected individually or in combination from: thermoplastics, thermoplastic elastomers, crosslinked polymers, UV-crosslinked polymers, isocyanates, additives, catalysts, release agents. By UV-crosslinkable is meant in particular UV-curable and by UV-crosslinked is meant in particular UV-cured.

The detachment layer is expediently transparent. It is preferred that the detachment layer has a smooth surface before the security element is laminated in. The detachment layer has in particular a low surface roughness, preferably an R3z value smaller than 2 μm, preferably smaller than 0.5 μm, before the lamination.

It has been shown that, when laminated in, a stronger adhesive force of the detachment layer to the adjacent cover layer or to the adjacent record layer can be achieved than the adhesive force within the adhesive layer and in particular the cohesive force of the adhesive layer. Furthermore, it is possible for the adhesive force of the detachment layer to the adjacent cover layer or to the adjacent record layer to be greater than the adhesive force between the adhesive layer and the cover layer or record layer adjacent to the adhesive layer. The separation behavior of the laminate can thus advantageously be set in a targeted manner via the adhesive layer.

The reflective layer expediently consists of a material with a refractive index which differs from the refractive index of the replication layer by at least 0.2. The reflective layer preferably comprises or consists of a metal layer or a high-refractive-index layer (=HRI layer, layer with a high refractive index) or combinations thereof. Typical materials of an HRI layer are ZnS and/or TiO₂ for example. The high-refractive-index layer can comprise or consist of materials selected individually or in combination from SiOₓ, MgO, TiOₓ, Al₂O₃, ZnO, ZnS. The variable x preferably lies in the range of from 0 to 3, thus x=0, 1, 2, 3. The reflective layer can comprise or consist of the following metals individually or in combination: chromium, aluminum, gold, copper, tin, indium, silver and an alloy of one or more of the above metals. It is also possible for the reflective layer preferably to contain one or more metal oxides, selected from aluminum oxide, chromium oxide, silicon oxide, indium tin oxide, titanium oxide and combinations thereof. The reflective layer preferably has a refractive index of more than 1.9 for wavelengths in a range of from 420 nm to 780 nm. The layer thickness of the reflective layer lies in particular in a range of from 40 nm to 200 nm, preferably in a range of from 40 nm to 100 nm. The layer thickness preferably relates to a layer of the reflective layer. In the case of a multi-layered reflective layer, one or more of the layers can in particular have the specified layer thickness.

The reflective layer is typically vapor-deposited or sputter-deposited in a vacuum. The reflective layer can also be applied or have been designed only partially and/or have different thicknesses in partial regions.

On the side of the adhesive layer which faces the replication layer and the reflective layer, the security element preferably has a stabilization layer. Through the stabilization layer, it is achieved in particular that the laminate can be formed such that a cohesive failure can be provided in the adhesive layer or a cohesive failure becomes more likely when the cover layer is peeled off, for example in the case of a relatively thin adhesive layer, which would alone still tend toward an adhesive failure. The stabilization layer advantageously at the same time fulfills a protection function during the laminating-in by serving to largely preserve the brilliance of the optical effects during the lamination and to prevent warping of the security element, in particular of the transfer ply with the security element.

The stabilization layer preferably has a thickness of from 0.5 μm to 20 μm, preferably in the range from 1 μm to 10 μm. It is possible in particular for the stabilization layer, preferably if the adhesive layer adheres to the record layer, to have a thickness of from 1 μm to 10 μm and/or, together with the thickness of the adhesive layer, to have at least 1 μm and/or, together with the thickness of the adhesive layer, at most 40 μm and/or to have a thickness 0.1 times to 20 times the thickness of the adhesive layer. In particular, it has proved to be advantageous that a ratio of the thickness of the adhesive layer to the thickness of the stabilization layer lies in a range of from 0.4 to 4.

It has proved to be advantageous that the stabilization layer has or consists of a layer which consists of a material with an elastic modulus in a range of from 500 to 1500 MPa.

The stabilization layer in particular comprises or consists of a material selected individually or in combination from: thermoplastics, thermoplastic elastomers, crosslinked polymers, UV-crosslinked polymers, isocyanates, additives, catalysts, release agents. The stabilization layer can be formed by a varnish crosslinkable by means of radiation or also by a chemically reactive varnish, such as for example an epoxy resin.

The stabilization layer preferably has a brittle behavior. During a separation attempt or during an elastic modulus measurement on a tensile specimen of the laminate, an elastic deformation of the stabilization layer advantageously takes place.

The stabilization layer is preferably transparent, in particular clear transparent. The stabilization layer preferably has a smooth surface. The stabilization layer can also consist of several layers and for example comprise an adhesion-promoter layer for binding to the reflective layer.

One or more further layers which fulfill further functions can be located between detachment layer and replication layer. For example, a protective layer can be provided, which is arranged between the detachment layer and the replication layer. This fulfills in particular a stabilizing mechanical action against degradation when the security element is laminated in between the record layer and the cover layer, in particular wherein record layer and the cover layer comprise or consist of polycarbonate. For this, such a protective layer has been or is preferably thermally stabilized, for example by a crosslinking by means of radiation or by means of a chemical reaction. The protective layer preferably comprises or preferably consists of materials selected individually or in combination from: thermoplastics, thermoplastic elastomers, crosslinked polymers, or UV-crosslinked polymers, isocyanates, additives, catalysts, release agents.

To laminate the security element in, a laminating method, preferably by means of a roll laminator or a lifting press, has been or is preferably carried out.

In the case of a roll laminator the record layer, the cover layer and the security element arranged between these two layers can for example be inserted between at least two heated rollers. In the case of a lifting press the record layer, the cover layer and the security element arranged between these two layers can for example be inserted between heated plates.

The laminating-in preferably has been or is carried out by means of a pressure of from N/cm² to 400 N/cm², preferably 40 N/cm² to 200 N/cm², which is exerted on the record layer, the cover layer and/or the security element. It is possible for the laminating-in to be or to have been carried out by means of a temperature of more than 150° C., preferably between 160° C. and 210° C., which acts on the record layer, the cover layer and/or the security element from a heat source, in particular from one or more of the heated rollers or one or more of the heated plates. The laminating-in preferably is or has been carried out by means of a contact time of the heat source with the record layer and/or the cover layer in a range of 1 minute or more and 30 minutes or less. The contact of the heat source with the record layer and the cover layer is preferably effected directly or indirectly via further layers. The above settings are preferably to be used for a record layer and a cover layer consisting of or comprising polycarbonate. For other materials, such as for example polyvinyl chloride, settings with respect to temperature and pressure differing therefrom, matched to the materials to be processed, can be used.

It is possible for the following steps to be carried out, in particular in the specified order, before or for the preparation of the cover layer or record layer provided with the security element:
preparing a transfer film with a carrier layer and with a transfer ply, wherein the transfer ply has the security element and the detachment layer is arranged on the side of the security element facing the carrier layer.
applying the security element to the record layer or to the cover layer.

A mechanically stable, thus in particular self-supporting, carrier film is expediently used as carrier layer. Typically, the carrier layer comprises or the carrier layer consists of polyester, preferably polyethylene terephthalate (abbreviated to: PET), or polyethylene naphthalate (abbreviated to: PEN). The thickness of the carrier layer preferably lies in a range of from 5 to 150 μm, preferably 5 to 50 μm, further preferably 10 to 25 μm. The carrier layer is preferably transparent.

The application of the security element is preferably carried out by means of the following steps, in particular in the specified order:
applying the adhesive layer to the record layer or to the cover layer
peeling the carrier layer off the transfer ply, with the result that the security element remains on the record layer or the cover layer.

The transfer ply can be transferred completely or in regions, for example through a pattern predefined by an embossing die or an embossing roller. Alternatively, an adhesive printed on in regions, in particular patterned, can bring about the transfer of the transfer ply in regions, with the result that the security element is formed of the printed-on adhesive and the transfer ply transferred in regions. The adhesive layer of the security element then preferably comprises or consists of the printed-on adhesive layer.

During the application the detachment layer expediently ensures that the layer composite of the transfer plies can be detached from the carrier layer. In particular, when the security element is laminated in, the detachment layer can surprisingly ensure that a good adhesion to the adjoining cover layer or record layer is achieved, in particular if they comprise or consist of polycarbonate. The detachment layer thus in particular fulfills a dual function since it guarantees an improved detachment during the production on the one hand and an improved adhesion in the final product on the other hand.

One or more wax layers can be arranged between the detachment layer and the carrier layer. In particular, the separation of the transfer ply from the carrier can be improved by one or more, preferably thin, wax layers. The thickness of a wax layer in each case preferably lies in a range of from 1 nm to 50 nm. The one or more wax layers are preferably removed before the security element is laminated in. In particular, a strong bond of the detachment layer to the record layer or the cover layer can be achieved hereby.

The application of the adhesive layer preferably has been or is carried out by means of hot stamping. It is possible in particular for the hot stamping carried out at a temperature of from 80° C. to 300° C., from 100° C. to 240° C., particularly preferably from 100° C. to 180° C. The hot stamping preferably has been or is carried out with a stamping pressure of from 10 N/cm² to 10,000 N/cm², preferably from 100 N/cm² to 5000 N/cm². The hot stamping preferably has been or is carried out with a stamping time of from 0.01 s to 2 s, preferably from 0.01 s to 1 s.

The relief surface of the replication layer preferably forms optically active structures. By optically active structures is meant in particular structures selected individually or in combination from: diffractive surface relief, holographic surface relief, first-order diffraction grating, zero-order diffraction structure, blazed grating, achromatic surface relief, surface relief in the form of a lens and/or a lens grid, an arrangement of micromirrors, microprisms, microlenses, microfacets, freeform surface, mirror surface, matte structure, in particular isotropic or anisotropic matte structure.

It is further possible for the replication layer to comprise or consist of thermoplastics or crosslinked polymers, preferably UV-crosslinked polymers. The replication layer preferably has a smooth surface before the replication. The thickness of the replication layer lies in particular in a range of from 0.2 μm to 20 μm, preferably in a range of from 0.2 μm to 10 μm.

A relief surface has been or is molded into the replication layer by a replication. The molding can be effected thermoplastically by structuring the surface by means of a tool which has the optically active structures as a correspondingly negatively shaped relief, preferably under pressure and temperature. The replication layer can also be formed of a polymerizable or polymerized varnish, preferably consisting of monomers and oligomers, which is or has been polymerized after or during the introduction of the relief surface. This polymerization can be effected by means of UV radiation or electron beam radiation. The replication layer can also represent a hybrid form by having been or being thermoplastically deformed and then cured. The replication layer preferably comprises or preferably consists of materials selected individually or in combination from: thermoplastics, crosslinked polymers, or UV-crosslinked polymers, isocyanates, additives, catalysts, release agents.

In the following, the invention is explained by way of example with reference to several embodiment examples with the aid of the accompanying drawings. There are shown in:

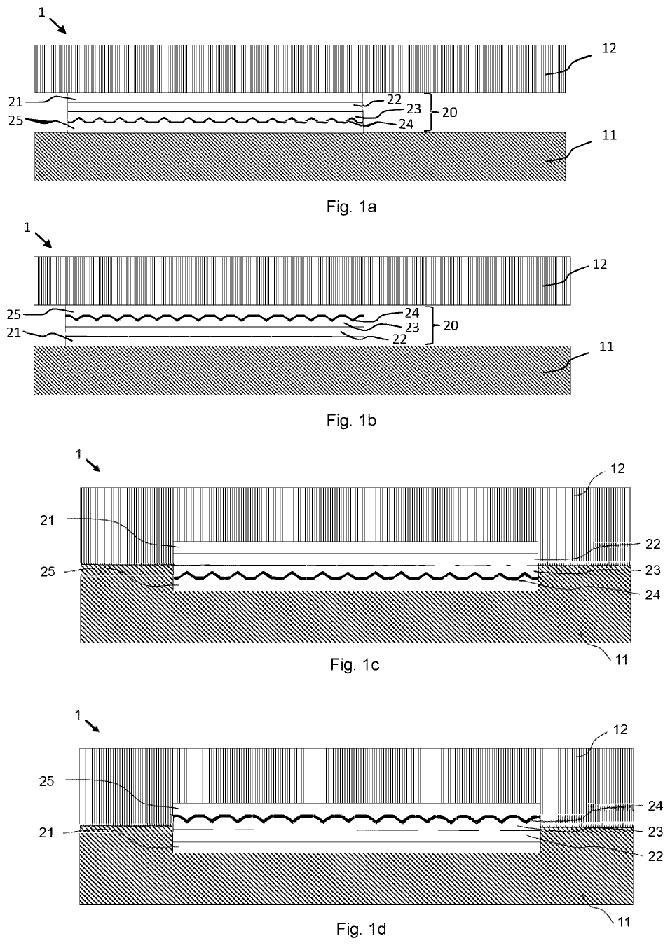

FIGS. 1a, 1b, 1c and 1d, schematically, a cross section of a laminate,

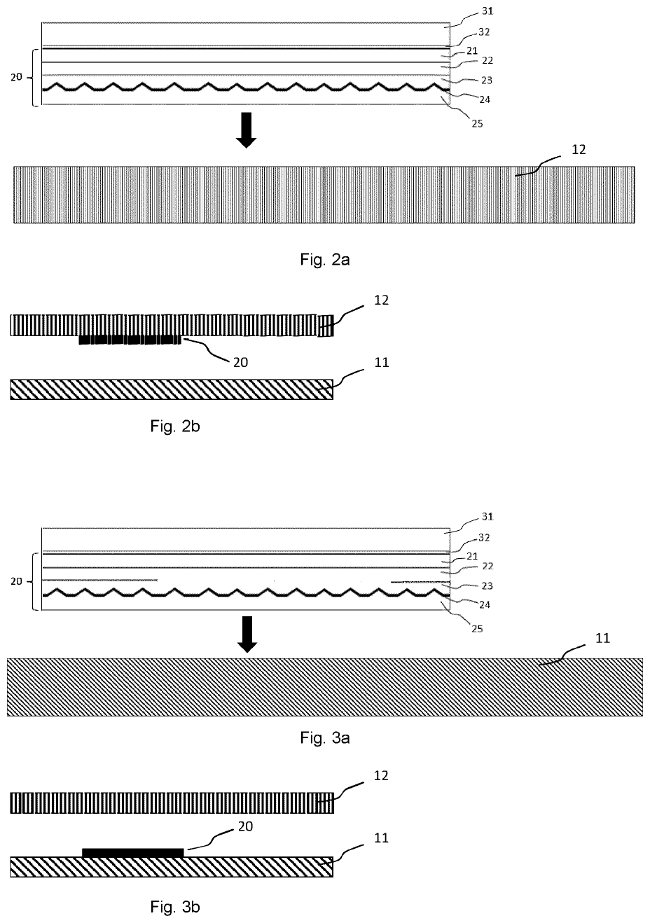

FIGS. 2a, 2b, 3a and 3b, schematically, a method for producing a laminate,

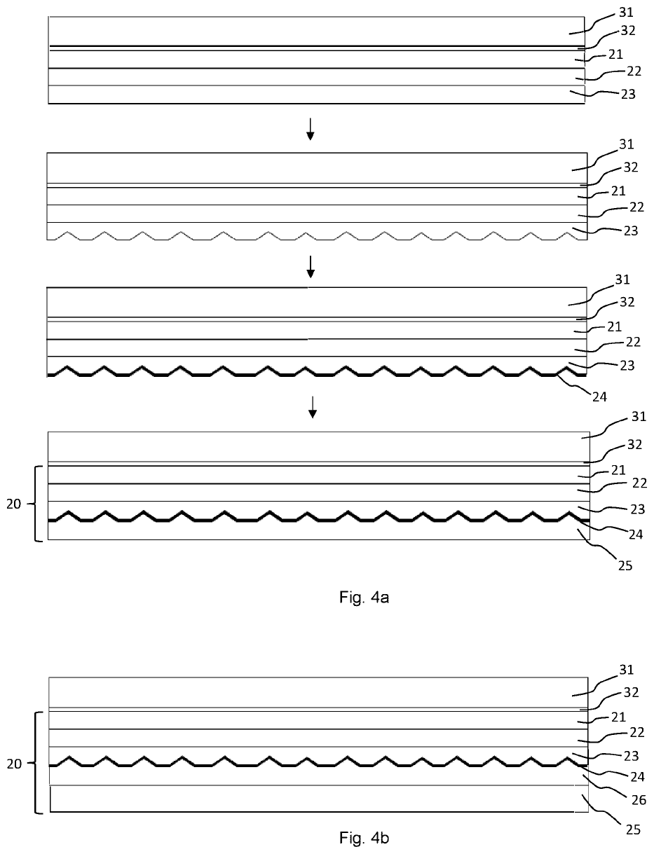

FIGS. 4a and 4b, schematically, a transfer film and the production thereof,

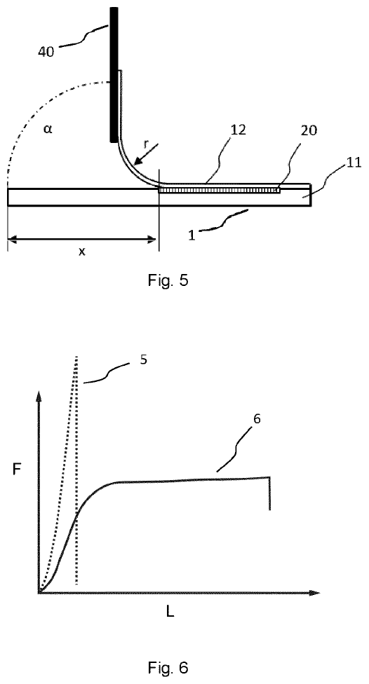

FIG. 5, schematically, the setup of a peel test,

FIG. 6 schematic measurement curves of a brittle and ductile material failure.

FIG. 1a and FIG. 1b show, schematically, in each case a laminate 1 in a cross section. The laminate 1 is preferably a security document.

The laminate 1 comprises a record layer 11, a transparent cover layer 12 and a security element 20. The security element 20 is laminated in between the record layer 11 and the cover layer 12. The security element 20 has a detachment layer 21, an optional protective layer 22, a replication layer 23 with a relief surface arranged on its side facing away from the detachment layer 21, a reflective layer 24 arranged on the relief surface and an adhesive layer 25.

The adhesive layer 25 forms a side of the security element 20 facing away from the detachment layer 21. The laminate 1 is designed such that the adhesive layer 25 of the security element 20 can be split up by a tensile force exerted on the security element 20 by the record layer 11 and the cover layer 12.

The adhesive layer 25 of the laminate 1 shown in FIG. 1a adheres to the record layer 11, wherein the detachment layer 21 adheres to the cover layer 12. The adhesive layer 25 of the laminate 1 shown in FIG. 1b adheres to the cover layer 12, wherein the detachment layer 21 adheres to the record layer 11.

In the depicted cross section the thickness of a layer is indicated in particular by the height, thus the dimension in the vertical direction. Viewing onto a plane or main surface spanned by the laminate or the layers thereof corresponds for example to a view from above. The adhesive layer 25 of the laminate 1 and of the laminate obtainable by the method according to the invention can be split up in particular by a tensile force exerted on the security element 20 by the record layer 11 and the cover layer 12. The presence of an adhesive layer 25 that can be split up or of a predetermined breaking point defined by the adhesive layer can be ascertained in particular by the peel tests described below based on the statements with regard to FIG. 5.

The join between the cover layer 12 and the record layer 11 is not shown in FIGS. 1a and 1b. Usually, however, no intermediate space is provided in the laminate 1 between the cover layer 12 and the record layer 11. The opposite surfaces of the cover layer 12 and of the record layer 11 are in particular fused together in regions outside the security element 20, as is illustrated for example by FIG. 1c and FIG. 1d and as can be achieved in particular with the method described here. In particular, the cover layer 12 and the record layer 11 form a monolithic body. By laminated in or laminating in is meant that a material-bonding join of the record layer 11 and cover layer 12 has been or is produced preferably by means of a laminating method, with the result that the security element 20 is completely enclosed by the two layers 11 and 12. In particular, the security element 20 has been or is laminated in by welding the record layer 11 and the cover layer 12 and in the process preferably completely surrounding the security element 20, preferably when viewed perpendicular to a plane or main surface spanned by the laminate 1, thus in a view from above in FIG. 1a and FIG. 1b.

The record layer 11 preferably contains further substances, such as in particular a doping. The capacity of the record layer 11 to absorb energy can be increased by means of the doping. Materials for a doping are selected in particular from one or more of the following materials: chromium, erbium, neodymium, praseodymium, titanium, ytterbium. Thus, an item of information has been or is inscribed in the record layer 11 for example by means of a laser, preferably a YAG laser, preferably a Nd:YAG laser (abbreviation for neodymium-doped yttrium-aluminum-garnet laser). The emitted wavelength of the YAG laser is preferably 1064 nm. The record layer 11 is thus processable by means of a laser in particular through the cover layer 12, in order to inscribe items of information in the record layer 11. The security element 20 preferably overlaps such items of inscribed information and thus increases the protection against forgery of the laminate 1, in particular security document.

The record layer 11 and/or the cover layer 12 comprises or consists of polycarbonate in a preferred embodiment. So-called composite laminates, in which the record layer and/or the cover layer consist of different materials, for example of PVC with a PET core, are likewise conceivable. It is advantageous in particular that the record layer 11 and the cover layer 12 comprise or consist of polycarbonate and have been or are joined to each other in a material-bonding manner, in particular welded together, by means of the laminating-in. During the laminating-in a particularly stable join can thus be achieved. A material-bonding join of polycarbonate layers, in particular consisting of almost 100% polycarbonate, which is achieved advantageously by a welding together in a laminating method, cannot be separated or can only be separated with difficulty by a forger. A detachment attempt, which makes use in particular of the adhesion reduced by the security element 20, was replicated by the tests below, in particular as described with regard to FIG. 5, and can be made more difficult by a cohesive failure and correspondingly selected geometry and material parameters, for example by increasing the peel force.

In the example of a laminate 1 described with reference to FIG. 1a, the following layer thicknesses can be implemented for example. In this example the cover layer 12 preferably has a layer thickness of from 50 μm to 150 μm. In this example the record layer 11 preferably has a thickness of from 50 μm to 150 μm. In this example the adhesive layer 25 preferably has a thickness of from 2 μm to 10 μm. In this example the reflective layer 24 preferably has a thickness of from 40 nm to 100 nm. In this example the replication layer 23 preferably has a thickness of from 0.2 μm to 10 μm. In this example the optional protective layer 22 preferably has a thickness of from 1.0 μm 10.0 μm.

In the example of a laminate 1 described with reference to FIG. 1b, the following layer thicknesses can be implemented for example. In this example the cover layer 12 preferably has a layer thickness of from 50 μm to 150 μm. In this example the record layer 11 preferably has a thickness of from 50 μm to 150 μm. In this example the adhesive layer 25 preferably has a thickness of from 2 μm to 10 μm. In this example the reflective layer 24 preferably has a thickness of from 40 nm to 100 nm. In this example the replication layer 23 preferably has a thickness of from 0.2 μm to 10 μm. In this example the optional protective layer 22 preferably has a thickness of from 0.1 μm to 10 μm.

The adhesive layer 25 adheres to the record layer 11 shown in FIG. 1a or to the cover layer 12 shown in FIG. 1b via an adhesive joint. The detachment layer preferably adheres to the cover layer 12 shown in FIG. 1a or the record layer 11 shown in FIG. 1b via a welded joint. The adhesive layer preferably adheres to the reflective layer through a material-bonding joint and/or to the replication layer 23 through a material-bonding joint. The reflective layer adheres to the replication layer 23 in particular via a material-bonding joint.

An adhesive force of the adhesive layer 25 to its directly neighboring layer consisting of cover layer 12 or record layer 11 is advantageously higher than the cohesive force of the adhesive layer 25. An adhesive force within the adhesive layer 25, in particular a cohesive force of the adhesive layer 25, is preferably lower than an adhesive force between the security element 20 and the record layer 11 and also lower than an adhesive force between the security element 20 and the cover layer 12.

It is advantageous in particular if the adhesive layer 25 has the lowest yield point, in particular the lowest upper yield point, and/or the lowest elastic modulus of the layers of the security element 20, the record layer 11 and/or the cover layer 12. A lowest force out of cohesive and adhesive forces within the security element 20 or within the laminate 1 with the security element 20 is preferably is the cohesive force of the adhesive layer 25. As is to be seen in FIGS. 1a and 1b, the adhesive layer 25 is in particular arranged over the whole surface and continuously in the security element 20.

The adhesive layer 25 preferably serves to bind a transfer ply of a transfer film, such as is described for example with regard to FIG. 4a and FIG. 4b, which carries one or more security elements 20 according to the invention, to the substrate during the application, i.e. in particular when the security element 20 is applied to the cover layer 12 and/or the record layer 11 as substrate. This can be an adhesive layer 25 which is activated by means of heat and pressure. A heated stamp, the shape of which defines the region to be transferred, is typically used for this. Alternatively, a transfer can be effected by means of a so-called cold transfer. A printed layer consisting of an adhesive, which forms the adhesive layer 25 in the laminate 1 or is comprised by the adhesive layer 25, is preferably printed onto the transfer ply of a transfer film, onto the cover layer 12 or onto the record layer 11. The cover layer 12 or the record layer 11 is then preferably brought into contact with the transfer ply and the printed layer consisting of adhesive is cured, in particular such that the security element 20 is formed of the transfer ply and the printed adhesive layer. The adhesive layer 25 can in turn be constructed of several different layers and include for example one or more adhesion-promoter layers, preferably in addition to the ductile layer, in order to ensure the binding of the adhesive layer 25 to the reflective layer 24 or to the optionally present stabilization layer.

It is also possible for the adhesive layer 25 to have or to consist of a ductile layer, in particular wherein by a ductile layer is meant a layer with the greatest elongation at break in the security element in comparison with the other layers of the security element.

It is hereby possible for the adhesive layer 25 to have or to consist of a ductile layer, wherein the ductile layer can be split up by a cohesive failure. The cohesive failure is advantageously favored, or an adhesive failure is made more difficult, by the ductile layer, in particular compared with a brittle adhesive layer. The peel force can be increased hereby.

In an advantageous embodiment the adhesive layer 25, in particular the ductile layer, comprises, consists of, a material with an elastic modulus in a range of from 20 MPa to 300 MPa, preferably from 50 MPa to 200 MPa, preferably from 75 MPa to 150 MPa. The elastic modulus is determined in each case according to DIN EN ISO 527-3:2003-07 (“Plastics—Determination of tensile properties—Part 3: Test conditions for films and sheets—issue date: 2003-07), preferably at room temperature (25° C.). The modulus of elasticity in tension is ascertained here on film test strips by means of a tensile testing machine (for example a tensile testing machine from ZwickRoell GmbH & Co. KG, Ulm, DE). The width of the film strips is preferably 15 mm+/−0.1 mm, the length of the film strips is preferably 100 mm+/−0.5 mm or 50 mm+/−0.5 mm for film materials with high elongation in particular. The test speed for a film length of 100 mm is 10 mm/min+/−1 mm/min or the test speed for a film length of 50 mm is 5 mm/min+/−1 mm/min.

The adhesive layer 25 preferably has been or is produced on the basis of polymethyl methacrylate. It is also possible for the adhesive layer 25 to comprise one or more additives selected individually or in combination from fillers, such as TiO₂, BaSO₄ or silica for example.

The adhesive layer 25, in particular the ductile layer, can be milky white.

The adhesive layer 25, in particular the ductile layer, has in particular a thickness in a range of from 0.2 μm to 20 μm, preferably in a range of from 0.2 μm to 10 μm. It is particularly preferred if the adhesive layer has a thickness in a range of from 3.5 μm to 20 μm, further preferably from 3.5 μm to 10 μm, and/or in a range of from 4 μm to 20 μm, preferably from 4 μm to 10 μm, and/or in a range of from 6 μm to 20 μm, in particular from 6 μm to 10 μm. The adhesive layer preferably has a glass transition temperature Tg in a range of from 20° C. to 50° C. Furthermore, a melting temperature Tm of the adhesive layer in a range of from 40° C. to 150° C. is preferred. In particular, the molar mass of the adhesive layer lies in a range of from 100 kg/mol to 350 kg/mol.

It is possible for the adhesive layer 25 to have a slightly rough surface before application to the cover layer 12 or the record layer 11. The surface roughness preferably lies between 0.4 μm and 2.0 μm, in particular between 0.6 μm and 1.0 μm. The measurements necessary for this are preferably carried out with a microscope, possibly a Keyence VK-X3000, and the software necessary for it, possibly VK Analyzer.

The detachment layer 21 has in particular a thickness in a range of from 0.2 μm to 10 μm, preferably in a range of from 0.2 μm to 5 μm, here for example 4 μm. It is possible for the detachment layer 21 to comprise or to consist of thermoplastics, thermoplastic elastomers or crosslinked polymers, preferably UV-crosslinked polymers. The detachment layer 21 comprises or consists of materials selected individually or in combination from: thermoplastics, thermoplastic elastomers, crosslinked polymers, or UV-crosslinked polymers, isocyanates, additives, catalysts, release agents. The detachment layer 21 is expediently transparent. It is preferred that the detachment layer 21 has a low surface roughness, in particular an R3z value smaller than 2 μm, preferably smaller than 0.5 μm, before the lamination.

For example, a reflective layer 24 consisting of aluminum with a layer thickness of 50 nm is used here. It is also possible for the reflective layer 24 to comprise or to consist of a metal layer or a high-refractive-index layer (=HRI layer) or combinations thereof. Typical materials of an HRI layer are ZnS and/or TiO₂ for example. The high-refractive-index layer can comprise or consist of materials selected individually or in combination from SiOₓ, MgO, TiOₓ, Al₂O₃, ZnO, ZnS. The variable x preferably lies in the range of from 0 to 3, thus x=0, 1, 2, 3. The reflective layer 24 can comprise or consist of the following metals individually or in combination: chromium, aluminum, gold, copper, tin, indium, silver and an alloy of one or more of the above metals. It is also possible for the reflective layer 24 preferably to contain one or more metal oxides, selected from aluminum oxide, chromium oxide, silicon oxide, indium tin oxide, titanium oxide and combinations thereof. The reflective layer 24 preferably has a refractive index of more than 1.9 for wavelengths in a range of from 420 nm to 780 nm. The layer thickness of the reflective layer 24 can lie in a range of from 40 nm to 200 nm, preferably in a range of from 40 nm to 100 nm, and is 50 nm here for example. The reflective layer can also have been designed only partially and/or have different thicknesses in partial regions.

On the side of the adhesive layer 25 which faces the replication layer 23 and the reflective layer 24, the security element 20 preferably has a stabilization layer 26.

The stabilization layer 26 advantageously fulfills its protection function during the laminating-in by serving to ensure the brilliance of the optical effects during the lamination and to prevent warping of the security element 20, in particular of the transfer ply with the security element 20. At the same time, through the stabilization layer 26, it can be achieved in particular that the laminate 1 can be formed such that a predetermined breaking point can be provided by a cohesive failure of the adhesive layer 25 or a cohesive failure becomes more likely when the cover layer 12 is peeled off, for example in the case of a relatively thin adhesive layer 25, which would alone still tend toward an adhesive failure.

The stabilization layer 26 preferably has a thickness of from 0.5 μm to 20 μm, preferably in the range from 1 μm to 10 μm. It is possible in particular for the stabilization layer 26, preferably if the adhesive layer 25 adheres to the record layer 11, to have a thickness of from 1 μm to 10 μm and/or, together with the thickness of the adhesive layer 25, to have at least 1 μm and/or to have a thickness 0.1 times to 20 times the thickness of the adhesive layer 25.

It has proved to be advantageous that the stabilization layer 26 has or consists of a layer which consists of a material with an elastic modulus in a range of from 500 to 1500 MPa.

The stabilization layer 26 in particular comprises or consists of a material selected individually or in combination from thermoplastics, thermoplastic elastomers or crosslinked polymers, or UV-crosslinked polymers, isocyanates, additives, catalysts, release agents. The stabilization layer 26 can be formed by a varnish crosslinkable by means of radiation or also by a chemically reactive varnish, such as for example an epoxy resin.

The stabilization layer 26 preferably has a brittle behavior.

The stabilization layer 26 is preferably transparent, in particular clear transparent. The stabilization layer 26 preferably has a smooth surface.

One or more further layers which fulfill further functions can be located between the detachment layer 21 and the replication layer 23. For example, an optional protective layer 22 can be provided, which is arranged between the detachment layer 21 and the replication layer 23. This fulfills in particular a stabilizing mechanical action against degradation when the security element 20 is laminated in, preferably in the record layer 11 and the cover layer 12 consisting of polycarbonate. For this, such a protective layer 22 has been or is preferably thermally stabilized, for example by a crosslinking by means of radiation or by means of a chemical reaction. The protective layer 22 here is formed for example on the basis of thermoplastics and/or thermoplastic elastomers and/or crosslinked polymers, preferably UV-crosslinked polymers, isocyanates, additives, catalysts, release agents.

It is further possible for the protective layer to be transparent, in particular to be highly transparent, and/or for the surface roughness of the protective layer to be low, for example smooth, in particular for an R3z value of the protective layer smaller than 2 μm, preferably smaller than 0.5 μm, to be provided.

The relief surface of the replication layer 23 preferably forms optically active structures. A relief surface has been or is molded into the replication layer 23 by a replication. The molding can be effected thermoplastically by structuring the surface by means of a tool which has the optically active structures as a relief, under pressure and temperature.

The replication layer 23 can also be formed of a polymerizable or polymerized varnish, preferably consisting of monomers and oligomers, which is or has been polymerized after or during the introduction of the relief. This polymerization can be effected by means of UV radiation or electron beam radiation. The replication layer 23 can also represent a hybrid form by being thermoplastically deformable and then being able to be cured. A corresponding relief surface has been or is molded into the replication layer 23 in particular by means of a replication tool by means of thermal replication and/or UV replication. The surface relief can also be or have been introduced by means of lasers. The replication layer 23 can also be a photosensitive layer, into which the relief surface is introduced by means of exposure to light, by exposing the replication layer 23 to light with a pattern of varying luminosity and then, depending on the type of photosensitivity, washing away or dissolving the regions of the replication layer 23 that have been exposed to light or not exposed to light, in particular by means of solvents.

The replication layer 23 preferably has a smooth surface before the replication. As material for the replication layer 23, it in particular comprises or consists of thermoplastics, crosslinked polymers, preferably UV-crosslinked polymers. UV-crosslinked polymers are cured in particular by UV irradiation with wavelengths in a range of from 100 nm to 400 nm. The replication layer 23 preferably comprises or preferably consists of materials selected individually or in combination from: polyester, polyurethane, polyacrylate, ethylene-vinyl acetate copolymer resins, polymethyl methacrylate, epoxy resins, cellulose-based resins.

The replication layer 23 is preferably not softened when the security element is laminated in. In particular, the softening temperature of the replication layer 23 lies above the laminating temperature of the laminating-in. It is hereby possible for the replication layer 23 and in particular the structures molded into the replication layer 23 to remain stable during the lamination. Here, for example, the brilliance of the decorative ply is preserved, for example by a relief surface molded therein remaining preserved, which guarantees in particular a high level of protection against forgery.

One of the following relief surface or a combination of two or more of the following relief surfaces is preferably provided here as relief surface: diffractive surface relief, holographic surface relief, first-order diffraction grating, zero-order diffraction structure, blazed grating, achromatic surface relief, surface relief in the form of a lens and/or a lens grid, an arrangement of micromirrors, microprisms, microlenses, microfacets, freeform surface, mirror surface, matte structure, in particular isotropic or anisotropic matte structure.

The replication layer 23 here preferably has different partial regions, into which different relief surfaces have been molded, which differ in particular in one or more relief parameters and/or consist of different ones of the above-listed relief surfaces. Several of the above-listed relief surfaces can also overlie each other.

The thickness of the replication layer 23 is 8 μm for example and can preferably lie in a range of from 0.2 μm to 20 μm, preferably in a range of from 0.2 μm to 10 μm.

The surface roughness of the replication layer is preferably very low, for example smooth, before the replication. In particular, the surface of the replication layer has an R3z value smaller than 2 μm, preferably smaller than 0.5 μm.

FIGS. 2a, 2b, 3a and 3b show a method for producing a laminate 1, which is in particular a security document. For example, a laminate can be produced hereby, such as is described with regard to one of FIGS. 1a to 1d and can in particular be used for the described tests.

In the method, the following steps are carried out, for example in the specified order:
preparing a record layer 11;
preparing a transparent cover layer 12;
preparing a security element 20.

The security element has a detachment layer 21, a replication layer 23 with a relief surface arranged on its side facing away from the detachment layer 21, a reflective layer 24 arranged on the relief surface and an adhesive layer 25, which forms a side of the security element 20 facing away from the detachment layer 21.

The security element 20 has been or is, as shown in FIG. 2a and FIG. 2b, applied to the cover layer 12 or, as shown in FIG. 3a and FIG. 3b, attached to the record layer 11. The security element 20 thus then adheres, with the adhesive layer 25, in particular to the cover layer 12 or to the record layer 11.

Depending on which of the two layers 11 and 12 the security element 20 is or has been applied to, the preparation of the respectively other layer can also be effected only thereafter. The record layer 11 and the cover layer 12 are then preferably arranged such that the security element 20 is arranged between these two layers.

A laminating of the security element 20 in between the record layer 11 and the cover layer 12 is then carried out. If the steps shown in FIGS. 2a and 2b went ahead, the adhesive layer 25 adheres to the cover layer 12 and the detachment layer 21 adheres to the record layer 11. If the steps shown in FIGS. 3a and 3b went ahead, the adhesive layer 25 adheres to the record layer 11 and the detachment layer 21 adheres to the cover layer 12. The two alternatives could optionally also be combined through the use of several security elements.

The adhesive layer 25 of the security element 20 is formed such that it can be split up by a tensile force exerted on the security element 20 by the record layer 11 and the cover layer 12.

With respect to specific designs of the security element 20, reference is also made in particular to the described embodiments of the security element of the laminate according to the invention.

To laminate the security element 20 in, a laminating method, preferably by means of a roll laminator or a lifting press, in particular has been or is carried out.

In the case of a roll laminator the record layer 11, the cover layer 12 and the security element 20 arranged between these two layers can for example be inserted between at least two heated rollers. In the case of a lifting press the record layer 11, the cover layer 12 and the security element 20 arranged between these two layers can for example be inserted between heated plates.

The laminating-in preferably has been or is carried out by means of a pressure of from N/cm² to 400 N/cm², preferably 40 N/cm² to 200 N/cm², which is exerted on the record layer 11, the cover layer 12 and/or the security element 20. It is possible for the laminating-in to be or to have been carried out by means of a temperature of more than 150° C., preferably between 160° C. and 210° C., which acts on the record layer 11, the cover layer 12 and/or the security element 20 from a heat source, in particular from one or more of the heated rollers or one or more of the heated plates. The laminating-in preferably is or has been carried out by means of a contact time of the heat source with the record layer 11 and/or the cover layer 12 in a range of 1 minute or more and 30 minutes or less. The contact of the heat source with the record layer 11 and the cover layer 12 is preferably effected directly or indirectly via further layers. The above settings are preferably to be used for a record layer 11 and a cover layer 12 consisting of or comprising polycarbonate. For other materials, such as for example polyvinyl chloride, settings with respect to temperature and pressure differing therefrom, matched to the materials to be processed, can be used.

FIG. 4a shows a transfer film and the production of the transfer film. FIG. 4b shows a further embodiment of a transfer film and the production thereof. Such a transfer film can be used to attach the security element 20 to the cover layer 12 or the record layer 11.

It is possible in particular for the following steps to be carried out, in particular in the specified order, before or for the preparation of the security element 20, as described with regard to FIGS. 2a, 2b, 3a and 3b, the cover layer 12 or record layer 11 provided with the security element 20:
preparing a transfer film as described with regard to FIG. 4a or FIG. 4b with a carrier layer 31 and with a transfer ply, wherein the transfer ply has the security element 20 and the detachment layer 21 is arranged on the side of the security element 20 facing the carrier layer 31.
applying the security element 20 to the record layer 11 or to the cover layer 12.

A mechanically stable, thus in particular self-supporting, carrier film 31 is expediently used as carrier layer 31. Typically, the carrier layer comprises or the carrier layer consists of polyester, preferably polyethylene terephthalate (abbreviated to: PET), or polyethylene naphthalate (abbreviated to: PEN). The thickness of the carrier layer preferably lies in a range from 5 to 150 μm, preferably 5 to 50 μm, further preferably 10 to 25 μm. The carrier layer is preferably transparent.

The application of the security element 20 is carried out for example by means of the following steps, in particular in the specified order:
applying the adhesive layer 25 to the record layer 11 or to the cover layer 12
peeling the carrier layer 31 off the transfer ply, with the result that the security element 20 remains on the record layer 11 or the cover layer 12.

The transfer ply can be transferred completely or in regions, for example by a pattern predefined by an embossing die or an embossing roller. Alternatively, an adhesive printed on in regions, in particular patterned, can bring about the transfer of the transfer ply in regions, with the result that the security element is formed of the printed-on adhesive and the transfer ply transferred in regions, for example without the adhesive layer or with the adhesive layer, preferably as adhesion-promoter layer, which is supplemented by the printed-on adhesive layer. The adhesive layer 25 of the security element 20 then preferably comprises or consists of the printed-on adhesive layer.

The application of the adhesive layer 25 to the record layer 11 or to the cover layer 12 preferably has been or is carried out by means of hot stamping. It is possible in particular for the hot stamping carried out at a temperature of from 80° C. to 300° C., from 100° C. to 240° C., particularly preferably from 100° C. to 180° C. The hot stamping preferably has been or is carried out with a stamping pressure of from 10 N/cm² to 10,000 N/cm², preferably from 100 N/cm² to 5000 N/cm². The hot stamping preferably has been or is carried out with a stamping time of from 0.01 s to 2 s, preferably from 0.01 s to 1 s.

As is shown in FIG. 4a, a transfer film can be produced by successively applying the optional wax layer 32, the detachment layer 21, the optional protective layer 22 and the replication layer 23 to the carrier layer 31.

During the application the detachment layer 21 expediently ensures that the layer composite of the transfer plies can be detached from the carrier layer 31. When laminated into the laminate 1 this layer additionally ensures in particular that a good adhesion to the adjoining cover layer 12 or record layer 11 is achieved, in particular wherein they comprise or consist of polycarbonate. One or more wax layers, such as the optional wax layer 32 shown in FIG. 4a and FIG. 4b, can be arranged between the detachment layer 21 and the carrier layer 31. In particular, the separation of the transfer ply from the carrier can be improved by one or more, preferably thin, wax layers. The thickness of a wax layer in each case preferably lies in a range of from 1 nm to 50 nm. The wax layer 32 is preferably removed before the security element is laminated in. In particular, a strong join of the detachment layer to the record layer or the cover layer can be achieved hereby.

Once the replication layer 23 has been applied, a relief surface can be molded into the replication layer 23 by a replication, as already described above. A reflective layer 24 can then be applied to the relief surface, in particular over the whole surface or else also over part of the surface or in regions, e.g. in the form of a pattern. For this, the reflective layer is for example vapor-deposited or sputter-deposited in a vacuum. As FIG. 4b shows, the optional stabilization layer 26 or, as FIG. 4a shows, the adhesive layer 25 can then preferably be applied directly to the reflective layer 24 and, in particular if the reflective layer 24 is deposited over part of the surface, also to the replication layer 23. As is shown in FIG. 4b, the optionally present stabilization layer 26 can additionally be applied between the adhesive layer 25 and the reflective layer 24, and in particular between the adhesive layer 25 and the replication layer 23, before in this case the adhesive layer 25 is then applied to the stabilization layer 26.

The adhesive layer 25 can also be constructed of several layers. For example, the adhesive layer 25, in particular in addition to the ductile layer, can include one or more adhesion-promoter layers, in order to ensure the binding of the adhesive layer 25 to the reflective layer 24 or to the optionally present stabilization layer 26. The layer of the adhesive layer 25 adhering to the cover layer 12 or record layer 11 in the laminate 1 can in particular be applied as a hot-glue layer of the transfer ply or be applied in a later step as a cold-glue layer to the transfer ply and, where appropriate, already present layers of the adhesive layer 25, or else to the record layer 11 or the cover layer 12.

FIG. 5 shows a setup for a peel test, such as is described above, in particular for a test according to ISO/IEC 10373-1: 2006 (E); paragraph 5.3.

In the peel test, in particular, an optionally pre-conditioned card is cut into test strips 10 mm wide. For example, FIG. 5 shows such a test strip of a laminate 1 schematically in a cross section.

For example, all layers on one side of the security element 20 are removed, preferably with a length of from 5 mm to 10 mm. The security element 20 is in particular a KINEGRAM®. The cover layer 12 is stripped off the core, i.e. in particular stripped off the record layer 11, for example with a sharp knife. The stripping expediently takes place only partially.

The stripped-off end is then preferably secured to the holder of a tensile testing machine via a holding clamp or by means of an adhesive tape 40. A right angle is preferably produced between the stripped-off layers secured to the tensile testing machine, in particular the cover layer 12, and the layers not stripped off, in particular of the corresponding part of the cover layer 12, the record layer 11 and the security element 20. In particular, a right angle is produced between the cover layer 12 and the record layer 11. The bottom of the laminate 1 or of the test strip thereof, in particular the record layer 11, can expediently be fixed on a stabilizing plate. During the tensile measurement the detached film layer can be guided over a roller. The adhesive force (peel strength) is preferably plotted on a graph and then evaluated, wherein the first and last 5 mm of the measurement are preferably not taken into account. The results are given for example in N/10 mm.

It is also possible for the measurement to be performed at locations without security element, for example in order to test the adhesive force between cover layer and record layer.

The influences of the different layers of the laminate 1 on the peel force can advantageously be ascertained by means of the peel force test. A dominant influence on the peel force is dissipation in the adhesive, wherein energy is converted in the cohesive failure. If a structure delaminates because of an adhesive failure, in particular at the boundary surface between adhesive layer 25 and cover layer 12 or record layer 11, much lower peel forces result than in the case of a cohesive failure. It is advantageously possible to set a peel force for detaching the cover layer 12 which is equal to or greater than 3.5 N/10 mm strip width.

The measurement of the elastic moduli can in particular be carried out as described in the following: the elastic modulus can be determined according to DIN EN ISO 527-3:2003-07 (“Plastics—Determination of tensile properties—Part 3: Test conditions for films and sheets—issue date: 2003-07), preferably at room temperature (25° C.). The modulus of elasticity in tension is ascertained here on film test strips by means of a tensile testing machine (for example a tensile testing machine from ZwickRoell GmbH & Co. KG, Ulm, DE). The width of the film strips is preferably 15 mm+/−0.1 mm, the length of the film strips is preferably 100 mm+/−0.5 mm or 50 mm+/−0.5 mm for film materials with high elongation in particular. The test speed for a film length of 100 mm is 10 mm/min+/−1 mm/min or the test speed for a film length of 50 mm is 5 mm/min+/−1 mm/min.

FIG. 6 shows by way of example, in comparison, the progression of a ductile material failure 6 as well as the progression of a brittle material failure 5 in a force-displacement diagram. The y axis indicates the force F and the x axis indicates the displacement L of the force-displacement diagram. The brittle material failure 5 is characterized in this respect in that the measured force rises very steeply and drops abruptly once the tensile strength of the material has been reached. In the case of a ductile material failure 6, on the other hand, the rise of the measurement curve proves to be markedly less steep, wherein the force remains at a substantially constant level once the yield stress has been reached. This material behavior is likewise shown in particular in the results of the peel tests. The dissipation in the region of the fracture tip or crack tip while the cover layer is being peeled off remains at as high a level as possible in particular in the case of a cohesive failure, which is not the case in an adhesive failure.

Example experiments and comparative tests for checking are described in the following.

In order to carry out a verification, corresponding patterns were produced for example. In particular, a hot-stamping film which had a thickness of 19 μm served as a basis (B944059, produced by Leonhard Kurz Stiftung & Co. KG, Fürth, DE). The film had the following structure: PET carrier, detachment layer, protective layer and replication layer. A relief surface was molded into the replication layer, wherein a cylindrical metal plate was pressed against the replication layer. The temperature of the plate was 180° C., the pressure was 100 N/cm², the production speed was 20 m/min.

A reflective layer consisting of zinc sulfite (ZnS) with a thickness of 60 nm was then applied to the relief surface by means of vacuum coating. In the gravure printing method an adhesive based on polymethyl methacrylate was then applied, wherein the adhesive layer was varied with respect to the layer thickness for the investigations. The following layer thicknesses were able to be determined after the solvent had been removed: 1 μm, 4 μm and 6 μm.

The security elements were then applied to a transparent cover layer consisting of polycarbonate (Makrofol ID 6-2, produced by Covestro AG, Leverkusen, DE) with a thickness of 100 μm or a transparent record layer consisting of polycarbonate (Makrofol ID 6-2 laserable, produced by Covestro AG) with a thickness of 100 μm. A hot-stamping transfer machine was used for this, wherein a stamping temperature of 170° C., a stamping pressure of 250 N/cm² and a stamping time of 0.5 s were used. After that, cards with a structure according to the standard ISO/IEC 7810: 2003 (E) were produced, wherein white polycarbonate (Makrofol ID 6-4, produced by Covestro AG) with a thickness of 100 μm was used for the rest of the card structure. For the patterns of experiment series 1 the adhesive layer of the security element formed an adhesive joint with the cover layer; for the patterns of experiment series 2 the adhesive layer of the security element forms a joint with the record layer. A process temperature of 190° C., a pressing pressure of 120 N/cm² and a pressing duration of 15 minutes were chosen for the laminating process necessary for this. Cards were subsequently punched out of the laminates.

The results of experiment series 1 show the peel forces with respect to the record layer and the security element. The results of experiment series 2 show the peel forces with respect to the cover layer and the security element. The peel forces were ascertained by a peel test, which was carried out according to ISO/IEC 10373-1: 2006 (E); paragraph 5.3 and/or the above-described peel test.

The results of these measurements can be seen in Table 1.

TABLE 1

| | Thickness of | Peel force | |
|---|---|---|---|
| | adhesive layer | [N/10 mm | Cohesive |
| | [μm] | strip width] | failure |
| Experiment | 1 | 0.8 | ◯ |
| series 1 | 4 | 2.6 | X |
| | 6 | 3.9 | X |
| Experiment | 1 | 0.7 | ◯ |
| series 2 | 4 | 2.4 | X |
| | 6 | 4.9 | X |

As can be seen in Table 1, the thickness of the adhesive in experiment series 1 displays an influence on the peel forces. These rise as the layer thickness increases. In the case of a layer thickness of 1 μm the peel force is 0.8 N/10 mm specimen width, attributable to an adhesive failure between the adhesive layer of the security element and the record layer. An increase in the layer thickness to 4 μm, on the other hand, leads to a cohesive failure, which is in turn indicated in a rise of the peel force to 2.6 N/10 mm specimen width. The increase in the layer thickness to 6 μm leads to a rise of the peel forces to 3.9 N/10 mm specimen width, wherein in turn a cohesive failure in the adhesive results. This behavior can likewise be observed in experiment series 2. Again, the peel force in the case of a layer thickness of 1 μm is the lowest, at 0.7 N/10 mm, wherein an adhesive failure between the adhesive layer and the cover layer occurs. The increase in the layer thickness to 4 μm leads to a cohesive failure in the adhesive, which is demonstrated by a rise of the peel force to 2.4 N/10 mm specimen width. In the case of a layer thickness of 6 μm a cohesive failure likewise occurred and the peel force increased to 4.9 N/10 mm specimen width. In particular, an adhesive layer that can be split up can correspondingly also be ascertained for different laminate structures.

In a comparison of experiment series 1 and experiment series 2 the following points can be established in particular:
The binding of the adhesive layer to the cover layer as well as to the record layer can result in comparable peel forces.
In the case of a thickness of the adhesive layer of 1 μm the two structures display an adhesive failure which can turn into a cohesive failure from a layer thickness of 4 μm.
In the case of both experiment series it is possible for a peel force of at least 3.5 N/10 mm specimen width to be able to be achieved in each case for the adhesive layer with a layer thickness of 6 μm.
It is possible for the alignment of the security element in the ply structure of the security document to display no influence on the fracture behavior in the adhesive layer of the security element in the case of a peel test.
In order to achieve a peel force of for example at least 3.5 N/10 mm specimen width, it is possible for the separation of the adhesive layer not to take place as a pure cohesive failure. A temporary change, for example a temporary drop or rise in the peel force, which can typically be observed during the transition from a cohesive failure to an adhesive failure, may be disregarded under defined conditions, in particular according to standard ISO/IEC 10373-1: 2006 (E); paragraph 5.3.

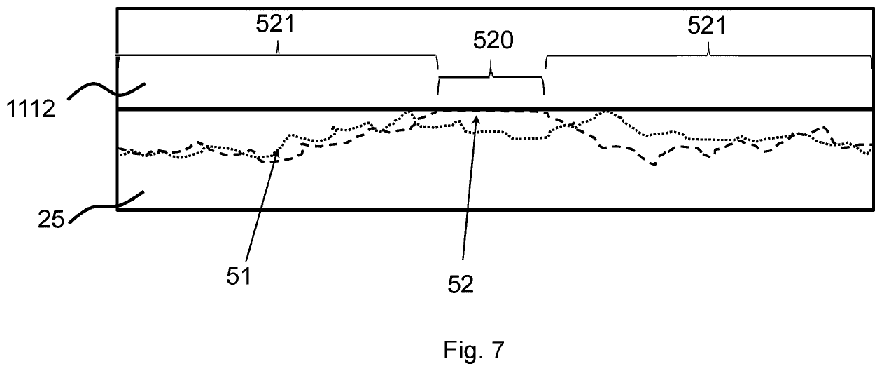

FIG. 7 schematically illustrates an example crack growth within a section of the laminate with the adhesive layer 25 and a layer 1112 directly adjacent to the adhesive layer 25. The layer 1112 is either the cover layer 11 or the record layer 12. The adhesive layer 25 and the layer 1112 thus have in particular a boundary surface which is formed between these layers or as a contact surface of the two layers. The cracks 51 and 52 are shown by the dashed lines in FIG. 7. In the case of a peel test and/or an attempt to detach the cover layer 11 and/or the record layer 12, thus in particular the shown layer 1112, one of the two cracks 51 and 52 can result for example.

As is illustrated by the crack 51, there is in particular the possibility that the crack tip temporarily hits a boundary surface between the adhesive layer 25 and the layers 1112 directly adjacent to the adhesive layer during the cohesive failure, but does not run along it in the case of an ongoing separation.

As is illustrated in particular with reference to the crack 52, it is possible for the laminate to be designed such that the adhesive layer 25 detaches in one or more partial surfaces, which here lie in the region 520, at a boundary surface with the directly neighboring layer 1112, which can be the case for example in the event of an adhesive failure. However, these one or more partial surfaces in the region 520 advantageously have a smaller surface area than a residual surface of the boundary surface, in particular with the result that the peel force is at least 3.5 N/10 mm. The residual surface is present here by way of example in the regions 521 for the crack 52. The residual surface of the boundary surface has in particular residues of the adhesive layer 25 in the region 521, since a cohesive failure took place there. The surface area is ascertained in particular when viewed along a line perpendicular to a plane spanned by the boundary surface, thus for example from bottom to top in FIG. 7.

The residual surface, which is present by way of example in the region 521, covers in particular at least 50%, preferably at least 80%, preferably at least 90%, of the surface area of the boundary surface and/or the partial surface, which is present by way of example in the region 520, covers less than 50%, preferably less than 20%, preferably less than 10%, of the surface area of the boundary surface.

Advantageously, in the case of irregularities in the laminate, which can lead for local peaks in tensile stress when the layer 1112 is detached and thus to local adhesive failures, predominantly a cohesive failure can thus also be brought about, with the result that overall a high peel force is still guaranteed. This is possible in particular also in the case of a relatively thin adhesive layer with a layer thickness of at least 3.5 μm.

In a preferred embodiment the adhesive layer therefore advantageously has a thickness of at least or more than 3.5 μm, preferably at least or more than 4 μm, in particular of at least or more than 6 μm.

### LIST OF REFERENCE NUMBERS

1 laminate
11 cover layer
12 record layer
1112 layer directly neighboring the adhesive layer
20 security element
21 detachment layer
22 protective layer
23 replication layer
24 reflective layer
25 adhesive layer
26 stabilization layer
31 carrier film
32 wax layer
40 clamp or adhesive tape
r radius
α angle
x length of stripped-off layer
L displacement
F force
5 brittle material failure
6 ductile material failure
51,52 cracks
510 region with partial surface
520 region with residual surface

1. A laminate comprising
a record layer, a transparent cover layer and a security element, which is laminated in between the record layer and the cover layer, wherein the security element has a detachment layer, a replication layer with a relief surface arranged on its side facing away from the detachment layer, a reflective layer arranged on the relief surface and an adhesive layer, which forms a side of the security element facing away from the detachment layer, wherein
a) the adhesive layer adheres to the record layer and the detachment layer adheres to the cover layer or the adhesive layer adheres to the cover layer and the detachment layer adheres to the record layer, and
b) the laminate is designed such that the adhesive layer of the security element can be split up by a tensile force exerted on the security element by the record layer and the cover layer.

2. The laminate according to claim 1, wherein
the adhesive layer has the lowest yield point and the lowest elastic modulus of the layers of the security element.

3. The laminate according to claim 1, wherein
an adhesive force of the adhesive layer to its directly neighboring layer consisting of cover layer or record layer is higher than the cohesive force of the adhesive layer.

4. The laminate according to claim 1, wherein
the peel force for detaching the cover layer is equal to or greater than 3.5 N/10 mm strip width.

5. The laminate according to claim 1, wherein
an adhesive force within the adhesive layer
is lower than an adhesive force between the security element and the record layer and also
is lower than an adhesive force between the security element and the cover layer.

6. The laminate according to claim 1, wherein
a lowest force out of cohesive and adhesive forces within the security element or within the laminate with the security element is the cohesive force of the adhesive layer.

7. The laminate according to claim 1, wherein
the adhesive layer has or consists of a ductile layer.

8. The laminate according claim 1, wherein,
the adhesive layer consists thereof a material with an elastic modulus in a range of from 20 MPa to 300 MPa.

9. The laminate according to claim 1, wherein
the adhesive layer has a layer thickness in a range of from 0.2 μm to 20 μm and/or in a range of from 6 μm to 20 μm.

10. The laminate according to claim 1, wherein
the adhesive layer contains thermoplastics or crosslinking or crosslinked polymers.

11. The laminate according to claim 1, wherein
the adhesive layer is semi-transparent and/or comprises one or more additives selected individually or in combination from fillers.

12. The laminate according to claim 1, wherein
the detachment layer has a thickness in a range of from 0.2 μm to 10 μm.

13. The laminate according to claim 1, wherein
the detachment layer comprises or consists of thermoplastics, thermoplastic elastomers or crosslinked polymers, or UV-crosslinked polymers.

14. The laminate according to claim 1, wherein
the relief surface of the replication layer forms optically active structures.

15. The laminate according to claim 1, wherein
the replication layer comprises or consists of thermoplastics or crosslinked polymers or UV-crosslinked polymers.

16. The laminate according to claim 1, wherein
the thickness of the replication layer lies in a range of from 0.2 μm to 20 μm.

17. The laminate according to claim 1, wherein
the reflective layer comprises or consists of a metal layer or a high-refractive-index layer or combinations thereof.

18. The laminate according to claim 1, wherein
the reflective layer has a refractive index of more than 1.9 for wavelengths in a range of from 420 nm to 780 nm.

19. The laminate according to claim 1, wherein
the layer thickness of the reflective layer lies in a range of from 40 nm to 200 nm.

20. The laminate according to claim 1, wherein,
on the side of the adhesive layer which faces the replication layer and the reflective layer, the security element has a stabilization layer.

21. The laminate according to claim 1, wherein
the stabilization layer has a thickness of from 0.5 μm to 20 μm.

22. The laminate according to claim 1, wherein
a ratio of the thickness of the adhesive layer to the thickness of the stabilization layer lies in a range of from 0.4 to 4.

23. The laminate according to claim 1, wherein
the stabilization layer has or consists of a layer which consists of a material with an elastic modulus in a range of from 500 MPa to 1500 MPa.

24. The laminate according to claim 1, wherein
the stabilization layer comprises or consists of thermoplastics, thermoplastic elastomers or crosslinked polymers, preferably UV-crosslinked polymers.

25. The laminate according to claim 1, wherein
the record layer and the cover layer comprise or consist of polycarbonate.

26. The laminate according to claim 1, wherein
the layer thickness of the cover layer satisfies one or a combination of the following conditions: the layer thickness of the cover layer, in relation to the layer thickness of the adhesive layer, lies in a range of from 1.25 to 250; the sum of the thickness of the adhesive layer and the cover layer lies in a range of from 26 μm to 270 μm; the cover layer has a layer thickness in a range of from 25 μm to 250 μm.

27. The laminate according to claim 1, wherein
the record layer has a thickness in a range of from 25 μm to 250 μm.

28. The laminate according to claim 1, wherein
the adhesive layer adheres to the cover layer or the record layer through an adhesive joint.

29. The laminate according to claim 1, wherein
the detachment layer adheres to the cover layer or the record layer via a welded joint.

30. The laminate according to claim 1, wherein
the adhesive layer adheres to the reflective layer through a material-bonding joint and/or adheres to the replication layer through a material-bonding joint.

31. A method for producing a laminate with the following steps:
preparing a record layer,
preparing a cover layer,
preparing a security element wherein the security element has a detachment layer, a replication layer with a relief surface arranged on its side facing away from the detachment layer, a reflective layer arranged on the relief surface and an adhesive layer, which forms a side of the security element facing away from the detachment layer, and the security element is or has been attached to the cover layer or to the record layer with the adhesive layer;
laminating the security element in between the record layer and the cover layer such that
a) the adhesive layer adheres to the record layer and the detachment layer adheres to the cover layer or the adhesive layer adheres to the cover layer and the detachment layer adheres to the record layer, and
b) the adhesive layer of the security element can be split up by a tensile force exerted on the security element by the record layer and the cover layer.

32. The method according to claim 31, wherein,
to laminate the security element in, a laminating method is carried out by means of a roll laminator or a lifting press.

33. The method according to claim 31, wherein
the laminating is effected by means of a pressure of from 10 N/cm2 to 400 N/cm2, which is exerted on the record layer, the cover layer and/or the security element.

34. The method according to claim 31, wherein
the laminating is effected by means of a temperature of more than 150° C., which acts on the record layer, the cover layer and/or the security element from a heat source.

35. The method according to claim 31, wherein
the laminating by means of a contact time of the heat source with the record layer and/or the cover layer lies in a range of 1 minute or more and 30 minutes or less.

36. The method according to claim 31, wherein
the following steps are carried out, in the specified order, before or for the preparation of the cover layer or record layer provided with the security element:
preparing a transfer film with a carrier layer and with a transfer ply, wherein the transfer ply has the security element and the detachment layer is arranged on the side of the security element facing the carrier layer;
applying the security element to the record layer or to the cover layer.

37. The method according to claim 31, wherein
the application of the security element is carried out by means of the following steps, in the specified order:
applying the adhesive layer to the record layer or to the cover layer;
peeling the carrier layer off the transfer ply, with the result that the security element remains on the record layer or the cover layer.

38. The method according to claim 31, wherein
the application of the adhesive layer is carried out by means of hot stamping.

39. The method according to claim 31, wherein
the hot stamping is carried out at a temperature of from 80° C. to 300° C.

40. The method according to claim 31, wherein
the hot stamping is carried out with a stamping pressure of from 10 N/cm² to 10,000 N/cm².

41. The method according to claim 31, wherein
the hot stamping is carried out with a stamping time of from 0.01 s to 2 s.
